(19) United States
(12) Patent Application Publication
(10) Pub. No.: US 2004/0192857 A1
(43) Pub. Date: Sep. 30, 2004

(54) Modified post-condensed polyesters

(75) Inventors: Camille Borer, Flurlingen (CH); Andreas Christel, Zuzwil (CH); Jan-Anders E. Manson, Chexbres (CH); Yves Leterrier, Lausanne (CH)

Correspondence Address: BURNS DOANE SWECKER & MATHIS L L P, POST OFFICE BOX 1404, ALEXANDRIA, VA, 22313-1404, US

(73) Assignee: BUHLER AG

(21) Appl. No.: 10/748,203

(22) Filed: Dec. 31, 2003

Related U.S. Application Data
(63) Continuation of application No. PCT/CH02/00177, filed on Mar. 26, 2002.

(30) Foreign Application Priority Data
Jul. 3, 2001 (DE) 101 32 928.8

(51) Int. Cl. C08G 63/91; C08L 67/00

(52) U.S. Cl. 525/418; 525/437; 525/438

(57) ABSTRACT

A method is disclosed for producing a modified polyester having improved rheological and mechanical properties. The method is characterised in that a polyester is mixed with a hyperbranched polymer (HBP), they are then melted down, the melted mixture is cooled to form a solid, and the solid mixture is then subjected to a solid phase postcondensation. A product is also disclosed which is produced according to the method, the postcondensed mixture being processed to form the product.

### CROSS REFERENCE TO RELATED APPLICATIONS

This application claims priorities under 35 U.S.C. §119 to German Application 101 32 928.8 filed in Germany on 3 Jul. 2001, and as a Continuation Application under 35 U.S.C. §120 to PCT/CH02/00177 filed as an International Application on 26 Mar. 2002 designating the U.S., the entire contents of which are hereby incorporated by reference in their entireties.

### BACKGROUND

The invention relates to a process for the production of a modified polyester with improved rheological and mechanical properties, to a product produced by the process with improved mechanical properties, and to an additive package which can be used for the production of such a modified polyester.

It is known that in order to improve the rheological and the mechanical properties, polyesters are processed together with reactive additives. If such processing is carried out in the melt, for example in an extruder, the polyester is subjected not only to the constitutional reaction with the reactive additive but simultaneously also to different degradation reactions which restrict or even counter-act a high molecular weight being achieved.

Particularly in those cases when additives with three or more functional groups are used is it possible for a non-homogeneous mixture of strongly cross-linked particles or gels to be formed in an otherwise low-molecular matrix.

Consequently, short processing times can be used which, however, do not allow all or almost all of the reactive sites of the reactive additive to react with the polymer.

It is also known that a complete reaction can be achieved by post-condensation in the solid phase. In this connection, attention should be paid to the fact that by using the usually small reactive additive molecules with only a few functional groups it is possible to link together only a small number of polyester chains without simultaneously causing cross-linking and thus non-homogeneity and/or embrittlement.

The danger of cross-linking arises also when using a multiply linear macromolecule with several functional groups.

When using reactive additives with only two functional groups, there is no danger of cross-linking occurring; however, branching in order to improve the rheological properties cannot be achieved.

### SUMMARY

Exemplary embodiments of the present invention are therefore based on providing a process in which a large number of polyester chains are linked together to form macromolecules with a high degree of branching and a very high molecular weight without causing a substantial amount of cross-linking.

An exemplary method includes:

Mixing and melting of a polyester with a hyperbranched polymer (HBP);

Converting the molten mixture by cooling into a solid form;

Executing a solid phase post-condensation on the mixture in the solid form.

By way of an exemplary process described herein, it is possible to produce specifically modified polyesters with special rheological and, ultimately, special mechanical properties for special end products from this polyester material by adjusting, in the above-mentioned steps, the following and, if necessary, further parameters as required:

the concentration of HBP in the mixture to be processed;

the type of HBP, in particular the type and number of the functional groups;

the treatment period in the step concerned;

the treatment temperature in the step concerned;

the intensity of the shear force exerted on the mixture;

and so forth.

In this way, it is possible to influence in particular both the degree of branching and the degree of cross-linking of the macromolecules in a controlled manner. It is thus possible, e.g. by increased branching of the individual separate molecules and simultaneously less cross-linking of the molecules, to achieve a high melt strength with a simultaneously low brittleness (high breaking strength) of the solidified melt (end product).

### DETAILED DESCRIPTION

PET

A polyester, in particular a thermoplastic polyethylene terephthalate, polybutylene terephthalate, polyethylene naphthalate or polycarbonate is used. Both new material and recycled material, in particular in the form of recycled PET bottle shreds, can be used. The polyester material can be present as a homopolymer or as a copolymer, the molecular weight of the polyester, measured as the intrinsic viscosity IV, being between 0.2 and 1.0, typically between 0.6 and 0.85 dl/g. Recycled material comprises material which arises as consumer recycling material and as industrial recycling material of products such as bottles, plastic films or fibres and is either processed directly or first sorted, washed and comminuted.

HBP

Hyperbranched polymer (HBP) or hyperbranched dendritic macromolecules is the term generally used for three-dimensional, strongly cross-linked molecules with a tree-type branching structure. These included the strongly symmetrical dendrimers as well as similar structures with a higher degree of asymmetry. Hyperbranched dendritic macromolecules can consist of a nucleus with one or several reactive sites or functional groups and a number of branching layers which consist of one or several branched chain extenders with at least three reactive sites or functional groups and, optionally, one or several separator layers and/or one layer of chain-ended molecules or functional groups, at least one reactive site or functional group being able to react with a reactive site of the polymer into which the HBP is to be incorporated, and lead to a compound. Exemplary functional groups for the reaction with polyester are e.g. hydroxyl, epoxy, anhydride or carboxyl groups. By repeating the branching layers, an increased number of functional groups can be achieved. A detailed description is given in WO 97/45474 which is herewith included in this application.

Additives

HBP can be added alone or as a component of an additive package. To produce the additive package, further additives are used from the group of toughening agents, nucleating agents, catalysts, dyes and pigments, stabilisers, compatibilisers, additives increasing the molecular weight or the elasticity, reinforcing fibres or fillers. In addition, a carrier material can be used into which all additives can be incorporated. The additive package can be present both as a homogeneous powder or in granular form as well as a simple additive mixture.

Processing: Mixing

Mixing and melting of the polyester with the HBP can take place in an extruder, kneader or any other suitable equipment such as a melt polymerisation reactor, for example, as it is used for the manufacture of polyester. Suitable extruders are both single-screw and twin screw extruders as well as multiple screw extruders such as a ring extruder or planetary extruder. The polyester and HBP can be introduced into the mixing equipment either simultaneously or in succession. HBP as a solid can be fed to the polyester both in the solid and in the molten state. It is also possible to melt the polyester and the HBP in separate machines and to mix them only subsequently.

The HBP can react with the polyester during melting and mixing. The process should be managed in such a way, in particular by controlling the residence time and the temperature, that not all free reactive end groups react with the polyester.

To process the polyester, it is appropriate to free the polyester and, if necessary, also the HBP of water. This is effected according to known drying methods either in a separate dryer or in an extruder, while the materials are still in the solid state, or by degassing of the melt.

Further process steps can follow onto the melting process such as a melt degasification, melt filtration, admixing and homogenising of further additives or a pressure build-up for moulding and conveying the material, for example. The molten material is returned to the solid form by cooling in contact with a suitable cooling medium such as air, water or a cooled surface. The material can be first pressed through a shaping die or pressed into a mold. A usual process is granulation, for example by strand pelletising or die-phase pelletising. However, it is also possible to use films or other shaped sections, if necessary after comminution.

Processing: Solid Phase Post-Condensation and Crystallisation

During the step of solid phase post-condensation, part or all of reactive end groups of the HBP, which are still free, react with the polyester. At the same time, the molecules of the polyester react with each other. Both reactions lead to an increase in molecular weight, a branched or cross-linked modified polyester being formed, depending on the quantity of HBP and the completeness of the reaction. In many cases, cross-linking is undesirable (brittleness) and the HBP concentration and the process conditions are chosen in such a way that a branched modified polyester is formed.

The solid phase post-condensation can take place both continuously and as a batch process under vacuum or in a gas stream such as air, nitrogen, steam or carbon dioxide.

Before the step of solid phase post-condensation, a crystallisation step can take place. This crystallisation step can take place as part of the cooling or granulating process or within the post-condensation reactor. However, the crystallisation step can also take place in a separate process step. Typically, use is made of reactors with mechanical stirrers in which the product is heated or of equipment in which the product is heated by a gas stream and agitated, e.g. in a fluid bed, fluidised bed or bubbling bed apparatus. Crystallisation can take place in one or several steps.

The solid phase post-condensation can be followed by a further step for cooling or for further processing. Cooling can take place as part of the post-condensation process or a in a separate process step.

The following experiments clarify exemplary advantages of exemplary processes according to the invention. The results of the measurements are summarised in Table 1.

### EXAMPLE 1

Polyester granules (Eastman, 9921W) were ground and dried for 12 hours at 105° C. under vacuum. The material was extruded in a unidirectional twin-screw extruder (Prism TSE 16) at 220° C. in the feed area, 265° C. in the melt and conveying area and 240° C. at the die and subsequently granulated. The viscosity of the solution (IV) in phenol/dichlorobenzene and the stretching viscosity at 270° C. by capillary rheometer with a discharge device were measured and used to determine the tensile stress at the stretch ratios concerned.

The tensile stress is calculated as follows:

F*(Vf−Vo)Ad/Vo

The stretch factor is calculated according to Vf/Vo

where F=take-off tension

Vf=take-off speed of the thread

Vo=discharge speed from the die

Ad=die surface

### EXAMPLE 2

2 kg of the extruded polyester granules from example 1 were subsequently crystallised for 20 minutes at 175° C. in air in a fluid bed reactor. 0.5 kg of the product were post-condensed for 7 hours at 210° C. in a stream of nitrogen and subsequently rapidly cooled. The determination of the tensile stress at given stretch/drawing ratios and of IV was again carried out.

### EXAMPLE 3

Polyester granules (Eastman, 9921W; IV=0.8) were ground and mixed with 0.04% of an HBP, also ground (Perstop, Bolteron H20, a two-layer dendritic polymer with 16 theoretical primary hydroxyl groups and a molecular weight of 1747 g/mole) and processed and measured in an analogous manner to the conditions of example 1.

### EXAMPLE 4

Extruded product from example 3 was processed and measured in a manner analogous to the conditions of example 2, the post-condensation, however, taking place over 5 hours at 210° C.

### EXAMPLE 5

Example 3 was repeated with 0.1% of the HBP.

### EXAMPLE 6

Extruded product from example 5 was processed and measured in a manner analogous to the conditions of example 2, the post-condensation, however, taking place over 4 hours at 210° C.

### EXAMPLE 7

Example 3 was repeated though with 0.04% of an HBP (Perstop, Bolteron H40, a 4-layer dendritic polymer with 64 theoretical primary hydroxyl groups and a molecular weight of 7316 g/mole).

### EXAMPLE 8

Extruded product from example 7 was processed and measured in a manner analogous to the conditions of example 2, the post-condensation, however, taking place over 6 hours at 210° C.

### EXAMPLE 9

Example 7 was repeated, though with 0.1% of the HBP.

### EXAMPLE 10

Extruded product from example 9 was processed and measured in a manner analogous to the conditions of example 2, the post-condensation, however, taking place over 5 hours at 210° C.

Column A: Example number

Column B: IV in [dl/g]

Column C: Tensile stress in (bar) with a stretch/drawing factor of 157

Column D: Maximum tensile stress (bar) with a maximum stretch/drawing factor

Column E: Maximum stretch/drawing factor

TABLE 1

| A | B | C | D | E |
|---|---|---|---|---|
| 1 | 0.83 | 11.2 | 21.6 | 231 |
| 2 | 1.06 | 34 | 45.2 | 196 |
| 3 | 0.800 | 6.8 | 12.1 | 267* |
| 4 | 0.987 | 29.7 | 83.3 | 267* |
| 5 | 0.809 | 14.4 | 26.5 | 267* |
| 6 | 0.977 | 61.6 | 61.6 | 157 |
| 7 | 0.812 | 7.8 | 13.2 | 267* |
| 8 | 0.991 | 28.7 | 58.6 | 249 |
| 9 | 0.795 | 13.3 | 23.5 | 231 |
| 10 | 0.981 | 31.3 | 77.4 | 267* |

Maximum achievable stretch/drawing factor achieved without thread rupture.

The comparison of the data in table 1 shows that the ductility of a polyester can be improved by extrusion with an HBP, but not its tensile stress. In contrast, the tensile strength of a polyester can be improved by post-condensation, but not its ductility. However, if post-condensation is applied to a polyester with a low proportion of an HBP a material with a substantially improved tensile stress and ductility can be produced.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A process for the production of a modified polyester with improved rheological and mechanical properties, comprising:
mixing and melting a polyester with a hyperbranched polymer (HBP) to form a molten mixture;
converting the molten mixture into a solid form by cooling; and
subjecting the mixture in solid form to a solid phase post-condensation.

2. The process according to claim 1, wherein the polyester is a polyethylene terephthalate.

3. The process according to claim 1, wherein the polyester is a recycled polyethylene terephthalate.

4. The process according to claim 1, wherein the HBP has at least six free reactive groups.

5. The process according to claim 1, the reactive end groups of HBP being selected from the group consisting of hydroxyl, carboxyl, anhydride or epoxy groups.

6. The process according to claim 1, the HBP being present in a concentration, based on the polyester portion, of 0.005% to 5%.

7. The process according to claim 1, wherein the mixing and melting of the polyester and the HBP take place in at least one extruder.

8. The process according to claim 7, wherein the at least one extruder is a multiple screw extruder.

9. The process according to claim 7, wherein additional steps take place in the at least one extruder.

10. The process according to claim 9, wherein the additional steps include at least one of pre-drying, degassing, introducing of further additives and homogenising.

11. The process according to claim 9, wherein the additional steps include at least one of pressure build-up, melt filtration, degassing and homogenising.

12. The process according to claim 1, wherein the molten mixture is granulated.

13. The process according to claim 12, wherein the molten mixture is granulated by strand pelletising.

14. The process according to claim 1, wherein the solid phase post-condensation takes place at a temperature between 150° C. and 250° C.

15. The process according to claim 1, wherein the solid phase post-condensation takes place continuously.

16. The process according to claim 1, comprising:
crystallisation of the molten mixture before the solid phase post-condensation.

17. A product produced by a process according to claim 1, comprising:
processing the solid phase post-condensation as the product in a further process step.

18. The product according to claim 17, wherein the further process step is at least one of injection molding process, an extrusion blow molding process, a film extrusion process, a profile extrusion process, a foaming process and a process for the production of fibres, yarns or packaging tapes.

19. An additive package for the production of a modified polyester consisting of:
an HBP; and
at least one further additive, selected from the group consisting of toughening agents, nucleating agents, catalysts, dyes and pigments, stabilisers, compatibilisers, additives increasing the molecular weight or the elasticity, and reinforcing fibres or fillers.

20. The additive package according to claim 19, wherein reactive end groups of the HBP are selected from the group consisting of hydroxyl, carboxyl, anhydride and epoxy groups.

21. The process according to claim 1, wherein the HBP has at least twelve free reactive groups.

22. The process according to claim 1, the HBP being present in a concentration, based on the polyester portion, of 0.02% to 0.4%.
